(19) United States
(12) Patent Application Publication
(10) Pub. No.: US 2012/0090514 A1
(43) Pub. Date: Apr. 19, 2012

(54) Reusable Pallet System

(76) Inventors: William Thomas Price, Houston, TX (US); Peter Jay Zweig, Houston, TX (US)

(21) Appl. No.: 13/270,688

(22) Filed: Oct. 11, 2011

Related U.S. Application Data
(60) Provisional application No. 61/394,671, filed on Oct. 19, 2010.

(51) Int. Cl. B65D 19/22; B23P 11/00

(52) U.S. Cl. 108/51.11; 29/428

(57) ABSTRACT

A disclosed reusable pallet serves as device for packaging and shipping materials. Upon completion of the shipping function, the reusable pallet is configured so as to permit the legs and slave plates of the pallet to be manipulated, whereby the (i) physical nature of the pallet can be changed through a process of subtraction and addition, (ii) the pallet can be used as formwork for creating an object that can be used in a way other than for packaging and shipping materials, and (iii) the pallet can be altered through the augmentation of accessories that can change the function of the pallet.

### CROSS-REFERENCE TO RELATED APPLICATION

This application claims priority to and incorporates by reference U.S. Provisional Patent Application No. 61/394,671 entitled a method of design, fabrication and application of panels through the process of cycling.

### FIELD OF THE DISCLOSURE

The present disclosure relates to pallets for shipping materials and, more particularly, to a reusable pallet.

### BACKGROUND

Pallets are used for the packaging and shipping of materials. Once received at the destination, the pallets are generally disposed of or used again for the packaging and shipping of materials. When disposed of, the pallets take up valuable land fill space.

### BRIEF DESCRIPTION OF THE DRAWINGS

FIG. 1 is an image showing selected elements of an embodiment of reusable pallet;

FIG. 2 is an image further showing selected elements of an embodiment of a reusable pallet;

FIG. 3 is an image further showing selected elements of an embodiment of a reusable pallet; and

FIG. 4 depicts exemplary uses of embodiments of a reusable pallet.

### DESCRIPTION OF EXEMPLARY EMBODIMENTS

In the following description, details are set forth by way of example to facilitate discussion of the disclosed subject matter. It should be apparent to a person of ordinary skill in the field, however, that the disclosed embodiments are exemplary and not exhaustive of all possible embodiments.

In one embodiment, the reusable pallet may be used for constructing a three-dimensional structure including the steps of: disassembling the reusable pallet and upcycling (i.e., transforming a material that exists and is disposable or is inert into something of greater use and value) the reusable pallet packaging pallet into one of a plurality of structures including, but not limited to the following: a floor, wall, canopy, table, storage system utensils, and shipping containers. The reusable pallet may be transformed in at least four manners: (i) the functional nature of the reusable pallet (also referred to herein as the panel) can be changed, (ii) the formal properties of the panel can be manipulated, whereby the physical nature of the panel can be changed through a process of subtraction and addition, (iii) the panel can be used as formwork for creating an object that can be used in a way other than for packaging and shipping materials, and (iv) the panel can be altered through the augmentation of accessories that can change the function of the panel.

In this way, one embodiment of the pallet may become an armature for a multitude of products that can be connected to each other in a variety of ways that can ultimately be placed in an X-Y-Z axis to make enclosures. The pallet has the potential for numerous applications such as, but not limited to the following: a three dimensional structural system that can be used with integral or augmented connectors and the pallet, a vertical/horizontal floor, wall, canopy system that can be integrated into buildings with walls, floors or canopy, a rain harvesting and storage system for gray or potable water, furniture, surgical gurneys, garden beds, embedded utensils or medical supplies, lighting where the pallet is embedded with phosphorescent material to give off light, or lighting can be added, or water storage with the capability to be a solar hot water container or wall/floor/canopy for showers.

It will be appreciated, that the pallet has the inherent capability to respond to the needs of medical, water, and shelter requirements that are increasingly occurring from the world wide Social and Natural Disasters of the 21^{st} century. Embodiments of the pallet permit reusing the pallet as a number of items, including, a medical table, a bed, the skin of a building, a garden/water wall, a structural system, a container as a host for a variety of ingredients and storage, a mold for making adobe or concrete blocks, that can then be used for construction on site, as well as numerous other possibilities. In one embodiment, the pallet includes an integrated water container which may for the commingling of the two functional components of pallet and water storage. It will be appreciated that this synergistic relationship can thus be used in a variety of ways to become a unique, easily assembled three dimensional structure or by extrapolation a village. Embodiments of the panels may be used to address a multitude of issues and objectives, including, but not limited to the following: disaster relief, social and cultural sustainability, temporary housing for medical facilities, or for entertainment events, camping, the military, etc.

It will be further appreciated that by creating innovative packaging, lightweight materials, and structural components, the pallet represents a solution to assembling temporary housing for those left homeless from devastating natural and social disasters. The pallet demonstrates a cultural and environmental sustainability through component based thinking (the pallet provides for multiple levels of performance for methods of purification of water, food+medical supply storage, eating and sitting, water for showers and drinking, sun, rain +wind protection) and any number of permutations for an individual, for different size families and at a larger scale, for the housing of communities. The pallet provides the chance to resolve the conflict between the basic human need to survive with the desire to have a home. As an example, in one embodiment the components of one or more of the pallets may be dismantled after its initial transportation of materials use and then used as recycled material for cultural objects (such as tourist crafts), or to create permanent housing through augmentation by applying a layer of concrete or other materials to the enclosures within the interstitial space between the pallets. This cycle from temporary, to permanent, to cultural sustainability, ultimately insures the host culture of surviving economically, past the immediate response to the cruelties and blight of disasters.

The pallet may be constructed from the following plastics: polyethelene, polypropylene, etc., with additives such as, phosphorescence, etc. Further, dyes that can be embedded with color, or other material for luminescence, opacity and transparency can also be adjusted with additives in the pallets (each color having different qualities of light and heat absorption). In other embodiments, nanomaterials, etc. may be added to the pallet for strengthening properties (for bullet proof, flame retardant, ease of fabrication, or any other purpose). In yet another embodiment, the pallet may be constructed from metal, wood, or other materials that can be envisioned by those skilled in the art of this field.

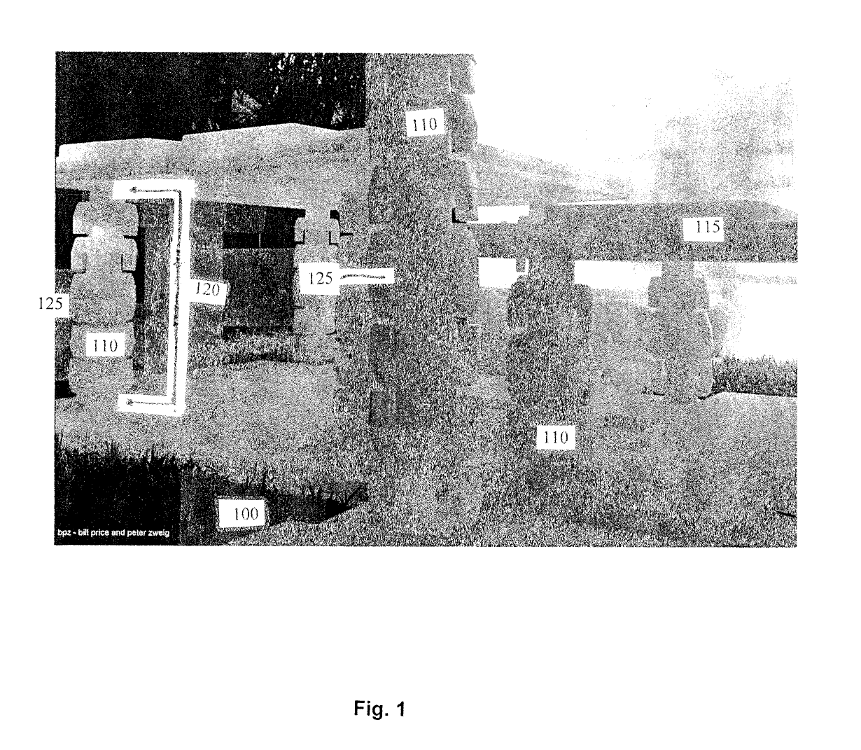

Turning now to the drawings, FIG. 1 is an image showing selected elements of an embodiment of reusable pallet system 100. Pallet system 100 may include multiple legs 110 and slave plates 115. Legs 110 may be connected directly to slave plate 115. In one embodiment, two or more legs 110 may be connected to one another to form column 120 which and column 120 may be connected to slave plate 115. It will be appreciated that in certain embodiments, legs 110 may be removably connected to one another and to slave plate 115 and in other embodiments, legs 110 may be fixedly connected to and integrated into slave plate 115. In other embodiments, each end of column 120 may be connected to a slave plate 115. In one embodiment, legs 110 may be configured to include raised tabs that may be interlocked to form intertwined legs 125. It will be appreciated that intertwined legs 125 may increase the stability of column 120. Slave plate 115 may be configured for use as a base, top, intermediate level, or wall. It will be further appreciated that leg 110 and slave plate 115 of pallet system 100 may be seen as variations of the panel and that each connection may follow one of the following typologies: (i) slave plate 115 to foot 110 connection: integral foot, screw/cup foot, tape/tie, x/y/z connector: triaxial, perforated, snap, other; (ii) slave plate 115 to slave plate 115 connection: slip/rod tie/tape, snap/screw, rotate, toe clip, cable: foot or pallet, puzzle pallet, slip seam, or other; and (iii) wall/roof/floor connection: rod: bamboo, r-bar, etc., tape, screw, cable, other.

It will be further appreciated that pallet system 100 may be augmented with accessories in a number of ways including: (i) tarp: waterproofing, cover, extensions, etc., (ii) concrete: spray, pour between panel 100 or indentations created in slave plate 115, etc., (iii) interstitial space in slave plate 115: this area can be filled with multiple materials including: adobe, insulation, concrete, etc., (iv) lighting: pallet 100 and slave plate 115 may be internally lit or used as a reflective surface, or embedded with phosphorescent or other material for luminescence, the opacity and transparency can be adjusted with color additives in the pallets (each color has different qualities of light and heat absorption, etc.), and (iv) wood/metal/other: other materials can be grafted onto pallet 100 for structural, decorative or functional reasons. It will be appreciated that the applications can be varied by other modifications such as, but not limited to the following: the change of scale (from nm to km), whereby the applications using pallet system 100 can become toys, cultural artifacts for fashion (purses, bags, etc.), tourist uses and crafts, the change of appearance through either the use of certain types of plastic (opacity vs transparency), or the use of color dyes in the plastic and/or the use of light to produce specific visual effects for design/entertainment or other purposes, the use of additives (in the polymer) such as nanomaterials, or other materials to strengthen the structure (for bullet proof use or flame retardant properties, or ease of fabrication, or any other purposes), and other items of relevance that others skilled in the art and by extension those in the field, could conceive and apply to this methodology of design, fabrication and application of panel system 100.

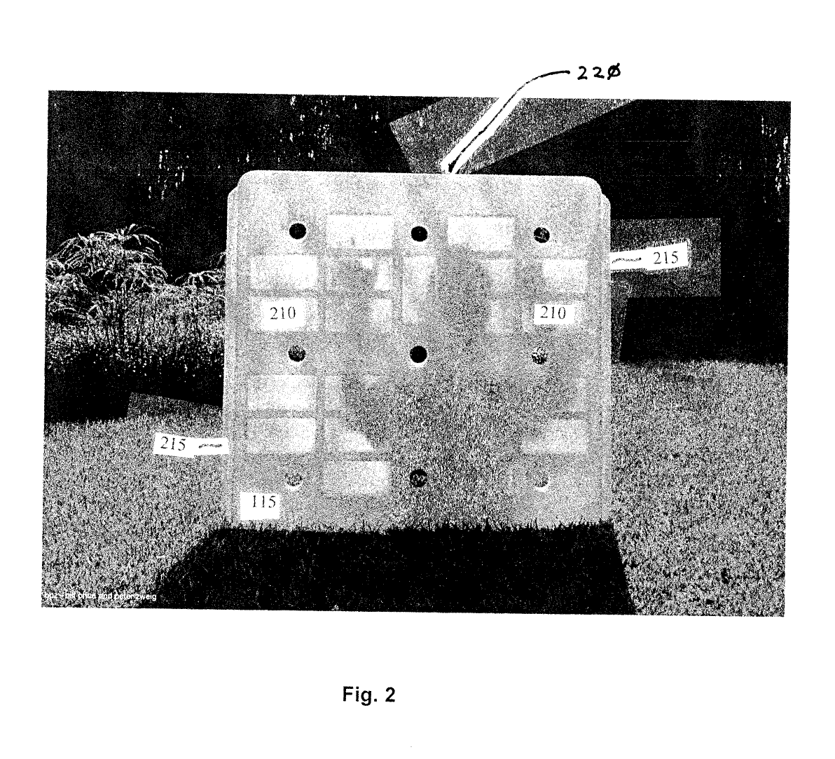

FIG. 2 depicts a side view of embodiment of slave plate 115. Slave plate 115 may contain recessed areas 210 and tabs 215. Surface 220 may contain a channel for receiving tab 215 of another slave plate to facilitate the interlocking of two or more slave plates. Further, it will be appreciated that slave plate 115 may contain areas for the secure storage of liquids as well as holes for the passage of air, liquid, light, and other materials.

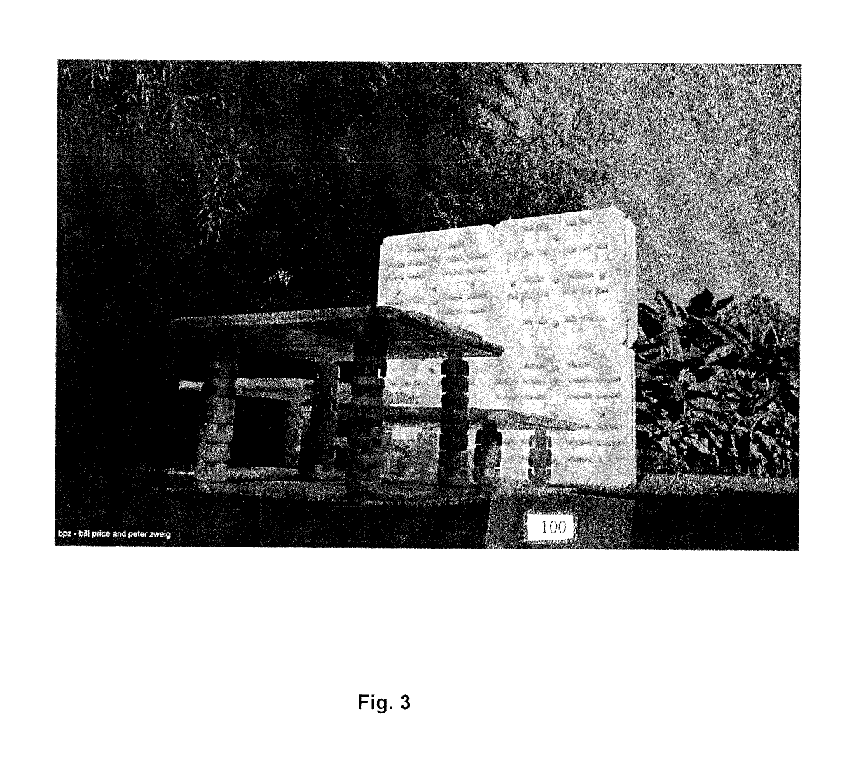

FIG. 3 depicts one embodiment of pallet system 100 reconfigured into a wall and tables.

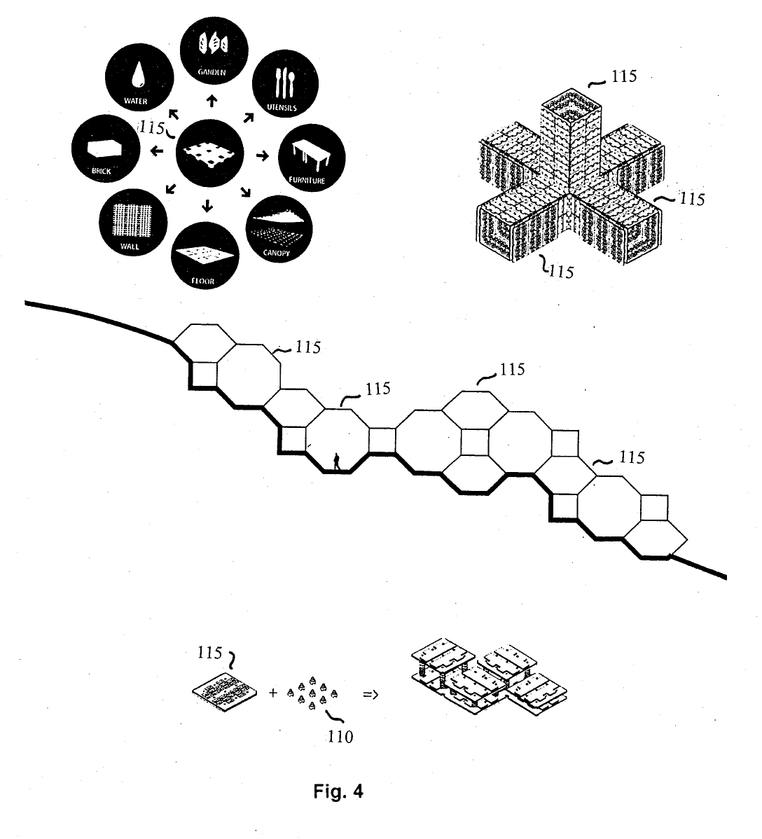

FIG. 4 depicts different manners in which legs 110 and slave plates 115 of pallet system 100 may be reconfigured into different structures.

To the maximum extent allowed by law, the scope of the present disclosure is to be determined by the broadest permissible interpretation of the following claims and their equivalents, and shall not be restricted or limited to the specific embodiments described in the foregoing detailed description.

What is claimed is:

1. A reusable pallet comprising:
a plurality of legs;
a first slave plate; and
a second slave plate; wherein the first slave plate and the second slave plate are configured to interlock with one another and further wherein the plurality of legs are configured to be removably connectable to the first slave plate and to the second slave plate.

2. A method for constructing a three-dimensional structure including the steps of:
disassembling a reusable pallet into a plurality of legs and at least one slave plate; and
configuring the plurality of legs and at least one slave plate into one of a plurality of structures including a floor, wall, canopy, table, storage system utensils, and shipping containers.

3. A method for constructing a three-dimensional structure including the steps of:
disassembling a reusable pallet into at least one slave plate; and
configuring the at least one slave plate into one of a plurality of structures including a floor, wall, canopy, table, storage system utensils, and shipping containers.

4. The method of claim 3 wherein the at least one slave plate further comprises an integrated leg.
